(19) United States
(12) Patent Application Publication
(10) Pub. No.: US 2024/0240371 A1
(43) Pub. Date: Jul. 18, 2024

(54) iNTERCHANGEABLE PLATING JACQUARD FABRIC AND THE LAMINATED WETSUIT THEREOF

(71) Applicant: HENG-WEN SHIUE, Wejie (TW)

(72) Inventor: HENG-WEN SHIUE, Wejie (TW)

(21) Appl. No.: 18/098,056

(22) Filed: Jan. 17, 2023

(51) Int. Cl. D04B 1/12; B32B 5/02; B32B 7/12; B32B 25/10; B32B 25/16; D04B 1/24

(52) U.S. Cl. CPC D04B 1/126; B32B 5/026; B32B 7/12; B32B 25/10; B32B 25/16; D04B 1/24; D04B 1/16; D10B 2331/04; D10B 2401/20; D10B 2501/04

(57) ABSTRACT

The object of the present invention is to provide an interchangeably plating Jacquard fabric which may be laminated with a Neoprene (or rubber foam) sheet to form a wetsuit to increase its snagging resistance, to prevent from being tacky to a Velcro tape (hook and loop fastener), and to provide beautiful decorative patterns on the wetsuit.

### BACKGROUND OF THE INVENTION

Typical wetsuits have to be close-fit for divers who can stay warm when diving underwater with water coming in and being warmed up by body temperature. In order to keep the close-fit for an easy putting on or taking off, without influencing the comfort stretch, a high elasticity of wetsuits is always required.

Besides, the diver may demand for aesthetics of wetsuit in addition to its functionality. Traditional jacquard fabric may be considered for creating patterns for aesthetics. However, there are two drawbacks, in that: one is its limitation to fabric elasticity at area of float-stitch, and the other is its vulnerability to snagging at area of convex point where two yarns, tuck-stitch and knit-stitch, are overlapped.

A conventional single jersey fabric as shown in FIG. 1 shows a single layer of white yarns as made by knit process. However, it is lacking of decorative pattern. So, it is not suitable for making a wetsuit when requiring decorative patterns or designs as revealed on the wetsuit.

Another conventional single jersey plating fabric as shown in FIG. 2 comprises an upper layer of black yarns and a lower layer of white yarns as plated under the black-ram layer by Knit process. Still, the two-layer fabric is lacking of decorative patterns, revealing a monotonous appearance. So, it is also unsuitable to make a wetsuit which requires more decorative patterns or designs.

As shown in FIG. 3, a fabric is obtained by Miss stitch. However, the float (length) F is shorter than the yarn loop (length), thereby limiting its elasticity as required by a wetsuit.

As shown in FIG. 4, another fabric is made by Tuck stitch. However, the location L, where two yarns are overlapped, may cause snagging easily. So, it is not suitable for making a wetsuit which should be snagging resistant.

Therefore, the present inventor has found the drawbacks of the prior arts, and invented the interchangeable plating jacquard fabric and the laminated wetsuit thereof.

### SUMMARY OF THE INVENTION

The object of the present invention is to provide an interchangeably plating Jacquard fabric, which may be laminated with a Neoprene (or rubber foam) sheet to form a wetsuit to increase its snagging resistance, to prevent from being tacky to a Velcro tape (hook and loop fastener), and to provide beautiful decorative patterns on the wetsuit.

### BRIEF DESCRIPTION OF THE DRAWINGS

FIG. 1 shows a first prior art.

FIG. 2 shows a second prior art.

FIG. 3 shows a third prior art.

FIG. 4 shows a forth prior art.

FIG. 5 shows a pattern design on the fabric for the wetsuit in accordance with the present invention.

FIG. 6 is a sectional drawing of FIG. 5 (from Line 6-6) showing a black yarn interchangeably plated on a white yarn, or a white yarn interchangeably plated on a black yarn in accordance with the present invention.

FIG. 7 is a cross-sectional drawing showing the Jacquard fabric laminated with the Neoprene sheet in accordance with the present invention.

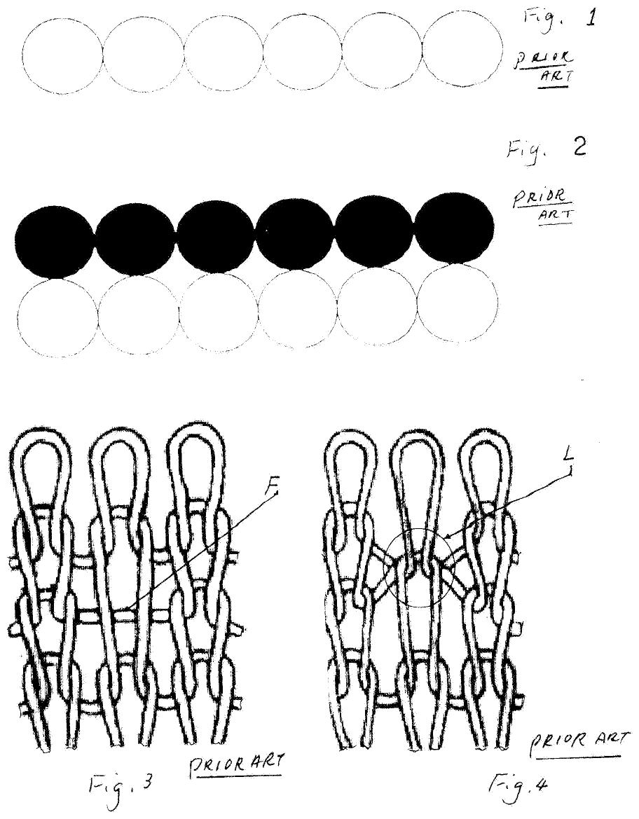

### DETAILED DESCRIPTION

As shown in FIGS. 5˜7, the present invention comprises: making of interchangeable plating Jacquard fabric; and lamination of the Jacquard fabric with the Neoprene (or rubber foam) sheet to foam the wetsuit or diving suit, which are described in detail as below-mentioned:

### A. Making Interchangeable Plating Jacquard Fabric:

A black yarn or first yarn (I) and a white yarn or second yarn (2) are respectively fed through a pair of feeder guides into a swingable yarn feeder (not shown).

Upon actuation of an electromagnetic actuator, the swingable yarn feeder will be swung to change the yarn-feeding angles in order to interchangeably plate the black yarn 1 on the white yarn 2, which are then knitted to form the Jacquard fabric of the present invention.

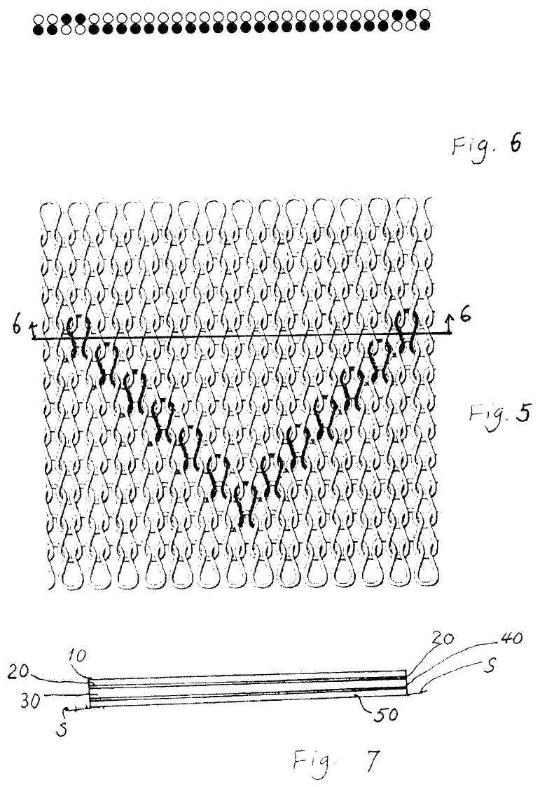

By interchangeably varying the face (or plating) yarns and the back (or ground) yarns according to a pre-set pattern program, a pattern, for example, as shown in FIG. 6 will be formed. Other patterns, more complex or more designs, may be further modified.

Logically speaking, a first yarn and a second yarn are interchanged to plate the first yarn on the second yarn, or to plate the second yarn on the first yarn alternatively.

Naturally, the black yarn or white yarn may be selected or processed by variating its properties or specification as follows:
1. Selection of raw materials of yarn, such as: Nylon 6, polyester and other materials.
2. Selecting two fibers with disparate color, preferably, one is dope dyed of any color, the other is white fiber to be dyed according to pattern design.
3. Choosing the processing ways, e.g., Draw Texturing Yarn (DTY), or Fully Drawn Yarn (FDY), but not limited.
4. Denier selection.
5. Functions. e.g., hydrophilicity or hydrophobicity of the yarn fibers.
6. High elasticity may be preferably fallen into the following range:
   Vertical elasticity (warp stretch): 170˜300%,
   Horizontal elasticity (weft stretch): 170˜300%.

### B. Formation of Wetsuit:

As shown in FIG. 7, the outer fabric 10 and inner fabric 50 as made from the foregoing steps may be laminated or sandwiched with a Neoprene (or rubber foam) sheet 30 to form a laminated wetsuit in accordance with the present invention.

In FIG. 7, the numerals as corresponding to their designations are shown as follows:
10 . . . outer fabric; 10:
20 . . . outer glue or adhesive; 20:
30 . . . Neoprene sheet; 30 Neoprene
40 . . . inner glue or adhesive; and 40
50 . . . inner fabric. 50

The laminated wetsuit is then worn on a user's skin S.

The present invention has the following advantages superior to the conventional Jacquard fabric and wetsuit:
1. The first yarn is interchangeably plated on the second yarn, and vice versa, so that when the first yarn presents color A (for example: black color) is plated on the second yarn of color B (such as white color), a pattern will be formed to provide the decorative appearance of the fabric and the laminated wetsuit.
2. The face yarn is stably plated on the back yarn to increase the snagging resistance of the knitted fabric. This snagging resistance is very important for a suit wearer or a diver when diving or swimming in water rich of reef or rocks. The stable plating structure of the fabric of the invention may prevent from scratch, snagging or frictional damage to the wetsuit and also for protecting the wearer's safety. The snagging resistance may also prevent from the wetsuit to be tacky to a Velcro tape which may be a part of the wetsuit. Due to the snagging resistance, the wetsuit may also be suitable when using a surfboard which requires high abrasion resistance.
3. The “double-layer” plating of a face yarn or a back yarn of the fabric, when adhered on Neoprene sheet by adhesive, may be well impregnated by the adhesive into the interface or boundary of the face yarn and the back yarn so as to firmly bond the plating fabric on the Neoprene sheet, thereby prolonging the service life of the wetsuit. The present invention may be further modified without departing from the spirit and scope of the present invention.

I claim:

1. An interchangeable plating Jacquard fabric as being made by respectively feeding a first yarn with color A and a second yarn with color B through a pair of eyelets into a swingable yarn feeder; and actuating an electromagnetic actuator to swing the swingable yarn feeder to alternatively change a yarn-feeding angle of each said first yarn and each said second yarn to interchangeably plate one yarn on the other yarn for knitting the Jacquard fabric.

2. A fabric of claim 1, wherein said first yarn is a black yarn and said second yarn is a white yarn.

3. A wetsuit as made by laminating at least a Jacquard fabric of claim 1 with a Neoprene sheet to form a wetsuit.
